(19) United States
(12) Patent Application Publication
(10) Pub. No.: US 2026/0027571 A1
(43) Pub. Date: Jan. 29, 2026

(54) COLD PERFORMANCE ENHANCING INTERACTION REGION MODIFIERS FOR FLUIDIC CIRCUITS

(71) Applicant: ABC TECHNOLOGIES, INC., New York (CA)

(72) Inventor: Alexander Dotzler, Potomac, MD (US)

(21) Appl. No.: 19/280,644

(22) Filed: Jul. 25, 2025

Related U.S. Application Data
(60) Provisional application No. 63/675,782, filed on Jul. 26, 2024.

(51) Int. Cl. B05B 1/08; B05B 7/04

(52) U.S. Cl. CPC B05B 1/08; B05B 7/0408

(57) ABSTRACT

Modified features can be implemented in various fluidic geometries so as to produce uniform oscillating sprays and improve the cold temperature and low pressure performance, especially with respect to ethanol. The features are bumps formed in or on the interaction chamber's floor, with the chamber itself has a greater depth than the power nozzles owing to a step that is the same height or slightly larger than the bumps. The bumps can present as symmetrical mirror images in the interaction chamber.

### CROSS REFERENCE TO RELATED APPLICATIONS

This application claims priority to U.S. provisional patent application Ser. No. 63/675,782 filed on Jul. 26, 2024, the entirety of which is incorporated by reference.

### FIELD OF INVENTION

This invention relates to fluidic systems, components, and apparatus capable of producing controllable, oscillating spray patterns and, more particularly, to a fluidic geometry to generate robust sprays, particularly those containing alcohol(s) mixed with aqueous-based cleaning fluids, at temperatures approaching or below the freezing point of water.

### BACKGROUND

Fluidic circuits and systems provide a means of creating spray fans with specific features. For example, these circuits and systems can produce a spray fan with an oscillating distribution pattern, but without the need to provide any motorized or moving parts within the hardware of the sprayhead. This characteristic has made fluidic circuits and systems particularly useful for dispensing cleaning solutions for vision systems and sensors, especially within the automotive field.

United States' U.S. Pat. No. 6,186,409 provides an example of a fluidic system colloquially known as having a “mushroom” configuration. In this patent, a chip or insert has a pattern of apertures formed within one of its surfaces, with the expectation that insert is sealingly received within housing that receives fluid, feeds the fluid into an inlet or plenum formed on the insert, and then has the outlet of the insert aligned with an aperture in the housing so that the housing dispenses a spray fan from that aperture. Owing to the geometric configuration formed on the insert, the dispensed spray may oscillate or otherwise possess specific characteristics. United States' patents 7,472,848 and 7,267,290 describe further improvements and embodiments of other oscillating geometries and inserts.

“Reverse mushroom” iterations of this design can be found in United States' U.S. Pat. Nos. 6,253,782; 11,305,297; 11,872,574; and 11,712,707. In these instances, mirror image power nozzles are positioned in the lower portions of interaction chamber, which itself is wider at the feed inlet at the top than it is closer to the throat positioned at the bottom (hence, the “reverse” nomenclature, as compared to the circuit in the preceding paragraph). The curving shape of the walls in the interaction chamber can be manipulated, as can the yaw/angle at which the spray is dispensed relative to the rectangular shape of the insert/chip. These configurations allow for further customization of spray performance, particularly at low temperatures.

United States' U.S. Pat. Nos. 7,651,036 and 10,532,367 rely upon a fluidic circuit configuration referred to as a “three jet island”. Here, the chip/insert includes a pattern in which the interaction chamber is defined in its upper extremities by a pair of “islands” that divide fluid flow into three discrete channels, including a power nozzle at the top of the interaction chamber and mirror image power nozzles. Another island is positioned within the interaction chamber between the power nozzles and immediately below/adjacent to the top inlet. This configuration produces an oscillating spray.

U.S. Pat. Nos. 9,987,639 and 9,776,195 contemplates the use of features (e.g. cylindrical protrusions, vertical splitters, etc.), downstream from a mushroom-shaped interaction chamber (i.e., in the outlet and downstream from the throat) to enhance spray uniformity and protect against water-hammer forces in a fluidic circuit specifically designed for agricultural/irrigation purposes, while United States patent publication 2010/0090036 contemplates the same features in mushroom circuits for automotive applications. Separately, United States' patent publication 2021/0114044 discloses features protruding downward from the island and partially into the interaction chamber.

Generally speaking, a mushroom circuit relies upon an interaction chamber where the power nozzles are in the upstream portion so as to direct jets along a downstream angle, whereas a reverse mushroom has the power nozzles directing jets along an upstream angle (usually from the downstream portion of the chamber). The various “jet island” circuits tend to rely on multiple discrete “islands” positioned around/defining the interaction chamber. These islands, by definition, present as full channel obstructions within the circuit/flow pattern so that, for a three-jet island, a third power nozzle is necessarily formed by the gap between the islands.

Other fluidic geometries are known, so that the foregoing configurations serve as examples. However, commonalities exist: the inlet/plenum feeds fluid to the insert, after which the fluid flows across the facing. Structural features direct fluid and alter its flow, including the use of one or more power nozzles, which constrict flow and eject side/angled jets into an interaction chamber. The shape of the chamber and the number of power nozzles creates fluid interactions resulting in turbulent and shifting flow patterns. Thus, upon exiting through the outlet at the downstream edge of the insert, the fluid is dispensed as a fan-shaped cone in which a jet moves (i.e., oscillates) so as to create a spray that may be uniformly distributed or tailored to deliver greater volume along selected portions of the spray fan (i.e., the arcuate dispensing range covered by that circuit).

All of the foregoing patents are incorporated by reference as background information.

Owing to their widespread use in outdoor applications (including automotive and sensor cleaning), fluidic circuits can and often are exposed to a wide range of temperatures. However, changes in pressure and/or viscosity, both of which can be influenced by changes in ambient temperature, can and do impact fluidic circuit performance. Thus, a fluidic geometry, insert, and/or system that produces reliable, oscillating sprays at a wide range of operating parameters (e.g., temperature, viscosity of fluid, low vs. high flow rates, desired size/shape/volumetric distribution of the spray fan, etc.) would be welcomed. Specifically, design features that can be implemented across a wide range of fluidic geometries in order to produce consistent, uniform spray patterns at cold temperatures and/or low pressures (both as defined herein) would be welcome.

### SUMMARY OF INVENTION

A fluidic geometry is formed on insert and/or as part of a housing or system. An inlet may pass through the thickness of the insert in order to feed a circuit inset on a major facing of the flat planar chip/insert. The combination of a cold step and interaction region modifiers disposed within the interaction chamber help kickstart oscillation and open the fan in a variety of different fluidic geometries at low temperatures and/or pressures. The cold step will have the same or greater depth in comparison to the height of the modifiers, and a modifier will be disposed within the jet produced by a pair of opposing power nozzles.

The interaction region modifiers may present as symmetrical, pill or bean shaped bumps oriented at an angle relative to the central axis of the circuit/insert. The interaction chamber is defined by a single island, sometimes formed in a C-shape centered around the central axis, so that power nozzles formed in the lower extremities between the edges of the island and the peripheral walls. The interaction chamber will retain its increased depth that carries through the throat and into the outlet.

The resulting fluidic geometries and inserts will maintain excellent fluidic properties at low temperatures and low operating pressures. As such, they are ideally suited for use in various sensor-cleaning and automotive applications.

### DESCRIPTIONS OF THE DRAWINGS

The appended drawings form part of this specification, and any information on/in the drawings is both literally encompassed (i.e., the actual stated values) and relatively encompassed (e.g., ratios for respective dimensions of parts, generalized comparatives, etc.). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure, including selected drawings which may be drawn to scale.

FIGS. 1A and 1B are identical three dimensional perspective images of the insert, showing the features etched into the top surface so as to produce the inventive fluidic circuit with the interaction region modifiers contemplated herein. FIG. 1A incorporates “bean-shaped” interaction region modifiers or bumps 50a, whereas FIG. 1B depicts “pill-shaped” interaction region modifiers or bumps 50b. The step down from the power nozzle to the floor of the interaction chamber is also visible in both views.

FIGS. 2A and 2B are corresponding top plan views of the insert of FIGS. 1A and 1B, respectively speaking.

FIGS. 3A and 3B are cross sectional views taken along a central axis of the inserts in FIGS. 2A and 2B, but with the bean and pill shapes superimposed over one another in a single image. In both, the downstream throat is positioned at the left edge, while the right portion of the insert (surrounded by posts) accommodates the inlet. FIG. 3A is shown in a three dimensional perspective view, while FIG. 3B is a side plan view to better emphasize the changes in depth, particularly in the interaction chamber in comparison to the bumps and the power nozzle.

FIGS. 4A (conventional reverse mushroom circuit) and 4B (reverse mushroom with modifications proposed herein) are photographs with arrows superimposed to comparatively illustrate the improved fluid flow that is believed to facilitate improved performance for the design depicted in FIG. 4B.

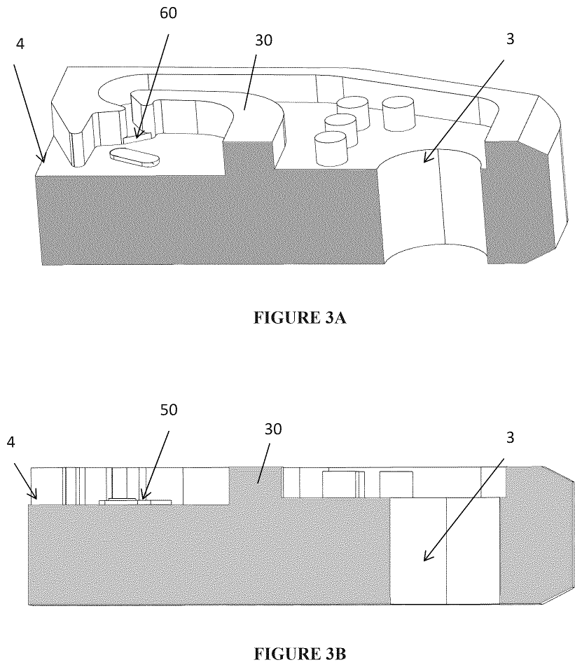

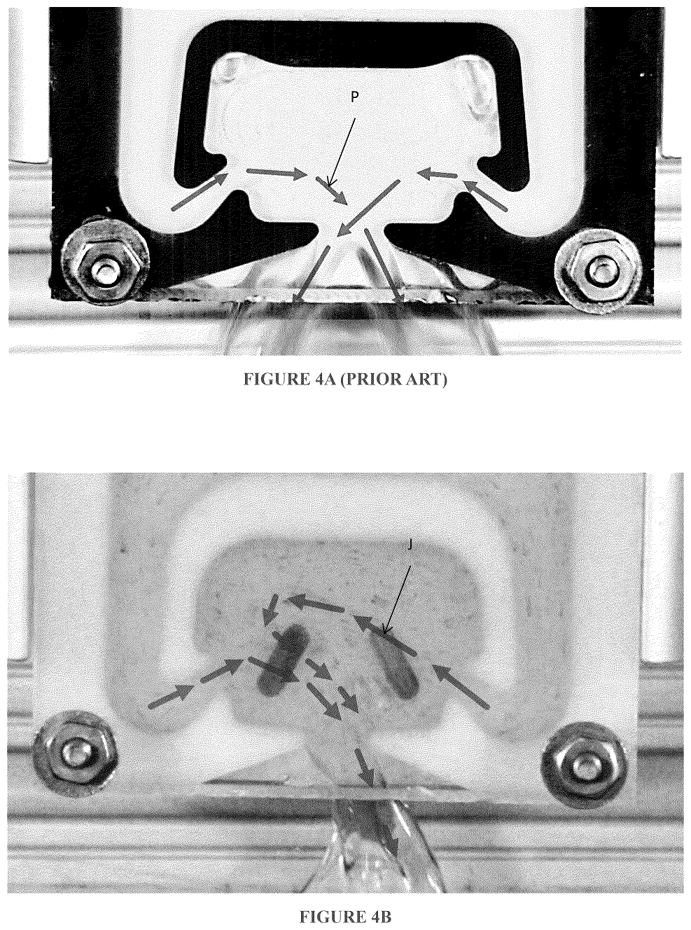

These dimensions, size, and spacing of the components depicted in FIGS. 2A, 2B, and 3B are drawn to scale, and a skilled person may discern comparative and absolute dimensions and ratios between such dimensions by taking appropriate measurements (beyond those specifically identified in the appendix). In addition to the stated values below, dimensions and angles identifiable within these Figures are incorporated as their absolute values, along with variations (including combinations and permutations to the extent ratios are disclosed) of plus or minus 5%, plus or minus 10%, or even up to plus or minus 20%.

### DETAILED DESCRIPTION

Operation of the invention may be better understood by reference to the detailed description, drawings, claims, and abstract—all of which form part of this written disclosure. While specific aspects and embodiments are contemplated, it will be understood that persons of skill in this field will be able to adapt and/or substitute certain teachings without departing from the underlying invention. Consequently, this disclosure should not be read as unduly limiting the invention(s).

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

The fluidic geometry or circuit will be formed on/in the facing of an insert. The insert is usually a flat, planar object that is etched, molded, or otherwise constructed to define a flow path in which one or more inlets are disposed at one end of the insert with a single outlet disposed at the opposing end/edge. Thus, reference to “top” or “upstream” means in the direction of the inlet(s), while “bottom” or “downstream” trends toward the outlet. This orientation coincides with how the circuits are depicted in the drawings. Also, because the flow generally proceeds parallel to the planar surface on/in the insert, “axial” refers to the top-to-bottom or vertical direction in the drawings, whereas “transverse” is any line horizontal or width-wise line that perpendicularly intersects with an axial line drawn down the center of the insert. “Depth” (measured from the top facing) and its corresponding term “height” (measured from the floor from which the feature protrudes) both refer to the elevation of specific features, and a transition in depth may occur according to step that is orthogonal to the major facing and/or along a sloping section.

This invention consists of a combination of features that provided within the interaction chamber, and these may be employed in a variety of fluidic circuits with different geometries. For example, reverse mushroom designs have been proven to derive particular cold temperature benefits (with cold temperatures understood to mean as low as the freezing point of the fluid flowing through the circuit or within 5° C. and up to 10° C. of that freezing point, e.g., for water, between 0° C. and up to 10° C.) and/or in operating conditions involving comparatively low pressures (with low pressures understood to mean less than 22 psi/1.52 bar or, in some aspects less than 10 psi/0.69 bar and even approaching 8 psi/0.55 bar).

The inventive features are effective when used in combination with an interaction chamber having a pair of opposing power nozzles, with a single island straddling the central axis in some aspects so that the lowermost edges of that island define the top facings of each power nozzle and the lower boundary wall provides the bottom facing for each nozzle. The inner wall of the island also defines the shape of the interaction chamber (which, as shown here is a reverse mushroom, although other shapes are contemplated as part of the invention, including those mentioned in the art cited above). It is also important that the features be provided within the interaction chamber, upstream from the throat, as the features are believed to be significant to creating specific effects inside of the chamber itself. Specifically, the spray fan is formed as it exits the throat, so that features downstream of the throat are not associated with turbulent flow patterns inside the interaction chamber itself (it being further understood that those flow patterns may impact, among other things, fluidic oscillation/switching).

The features themselves are two discrete structures. The first is a “cold step” at the power nozzle. This step tends to impact the aim of the fan spray. Specifically, fluid coming into the interaction region expands downward over the step and toward the floor as it progresses through the circuit, thereby introducing a downward velocity component to the flow. Thus, as seen in FIG. 3B, the cold step drops at an angle that is perpendicular (or +/−10° from perpendicular in some aspects) to the floor of the interaction chamber and, separately, the flow channel in the upstream reaches between the inlet and the interaction chamber.

In some aspects, a gradual incline (so as to reduce the depth in comparison to the step-down in the interaction chamber) can be imparted within the interaction chamber immediately upstream from throat to tune or balance the impact the cold step might have. However, the aspects depicted in the Figures here all rely on a flat planar surface throughout the floor of the interaction chamber extending similarly into the throat and outlet regions, and the consistent floor depth extending from the interaction chamber all the way through to the outlet is significant to certain aspects of the invention.

The second feature is a pair of interaction region modifiers or “bumps” protruding upward from the flat portion of the interaction chamber floor. These bumps will have a height that is less than the change in elevation imparted by the cold step. In some aspects, the bumps will be one half to three quarters of the total change in elevation by the cold step. In absolute terms, this means that, if the cold step drops 1.5 units, the bumps will be about 1.0 units in height. The shape and volume/area the bumps occupy (with the latter being relative to the total volume/area of the interaction chamber) can be adjusted to improve or tune the performance. For comparison's sake, the depth of the fluidic circuit upstream from the interaction chamber (including the power nozzles) will be about seven times greater than the height of the bumps, whereas the depth of the interaction chamber and the throat/outlet regions will be about 8.5 times greater than the height of the bumps.

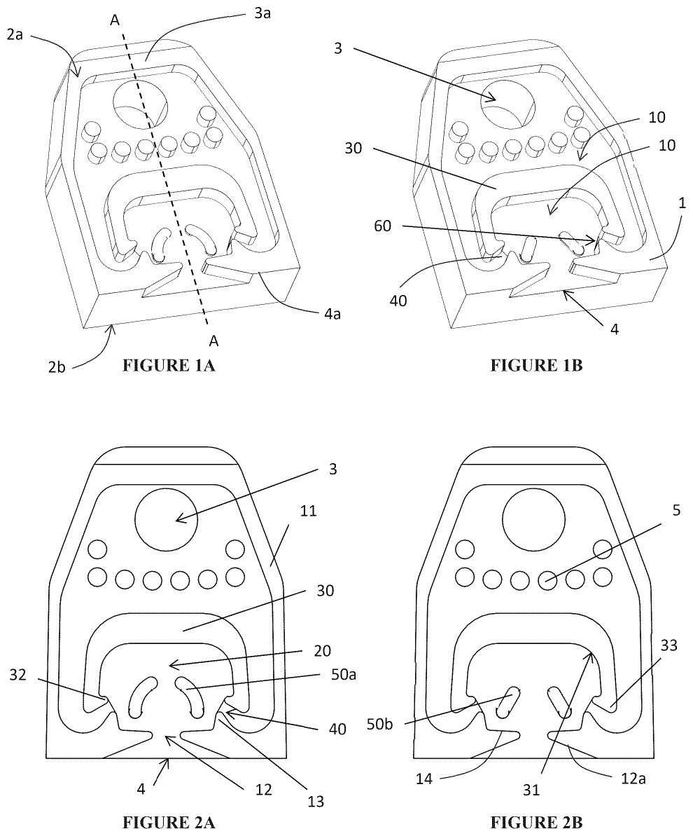

With reference to FIGS. 1A through 4B, the circuit 10 and insert/planar body 1 on which it is formed are preferably symmetrical about a central, vertical axis A-A. The circuit 10 comprises various fluidic features 10, such as an interaction chamber 20, defined by an island 30, power nozzles 40, and a throat. In certain aspects, features 10 all creating mirror images around the central axis A-A. As used herein, the term “fluidic” should be understood to mean a device having features specifically selected and engineered to produce desired flow patterns in fluids passing through the circuit.

The insert 1 is formed from a three dimensional body, such as a cuboid or three-dimensional polygonal shape. In all cases, the insert has a substantially flat planar surfaces with opposing facings 2a, 2b, with the fluidic features 10 (and all of its various features) is formed on at least one of those facings 2a, 2b. The features 10, as well as other aspects of the fluidic geometry, can be formed via conventional injection molding, etching, additive manufacturing, and the like, relying on a wide area of materials based upon the selected methodology. An inlet region 3 is formed near the top edge 3a, whereas the outlet 4 is provided along the bottom edge 4a.

A boundary wall 11 surrounds the entire fluidic geometry (i.e., features 10, as well as the inlet 3 and outlet 4) so as to contain and direct fluid flow. Owing to the shape of the insert 1, it can be fitted within a slotted housing or otherwise sealed by a separate component to enclose the circuit 10 along its open facing(s), except for inlet 3 and outlet 4. The boundary wall 11 itself includes sections that traces the shape of the outline of the facing 2a and/or 2b. In some aspects, rounded transitions are provided (e.g., at corners at both the top and the bottom of the circuit 10), while the height of the wall 11 (which also corresponds to the depth of the circuit itself) remains constant.

The inlet region 3 accommodates fluid flow provided from via an aperture 3b running between the facings 2a, 2b (as best seen in FIGS. 1A and 1B) or an plenum formed with the housing (not shown). A series of posts 5 may form a perimeter around the plenum/aperture to serve as structural support and/or as a filter that prevent large particles from flowing downstream into the more narrow channels of the circuit. In some aspects, the posts 5 do not extend to the same height away from the floor of the circuit in comparison to the boundary wall 11 and islands 30, so as to allow for greater tolerances in manufacturing and/or to provide additional flow paths downstream from the inlet point (see FIG. 3B). In some aspects, the boundary wall 11 in the inlet region 3 will increase in transverse width as it proceeds downstream toward the interaction chamber 20.

The outlet 4 is at the bottom 4a of the circuit flow. The outlet 4 itself is formed as an interruption within the boundary wall 11. The oscillating spray fan will exit and emanate from the outlet 14, either in parallel with the direction of plane coinciding with facing 2a and/or at an angle to that plane. In certain aspects, the transverse open width of the outlet 4 at the very bottom edge significantly larger than the transverse width of the throat 12, usually at least twice the width and up to five times the width (with about 3.5 to 4.0 times in certain aspects). The transverse width of the throat 12 will also be greater in measured length than the axial downstream travel from the narrowest part of the throat 12 to the edge 4a where the outlet 4 terminates (with the throat being about 1.75 to 2.25 times this distance in certain aspects). The sidewalls 12a running from the narrowest point of the throat 12 out to the bottom edge of the outlet 4 are straight edges, although the throat 12 itself may possess rounded edges as it transitions from the interaction chamber 20 facing to the outlet 4 facing.

The interaction chamber 20 is generally responsible for producing the desired fluidic effects although, as previously noted, the chamber 20, island 30, power nozzles 40, and combination of the bumps 50 and cold step 60 all contribute to the fluidic performance characteristics). The shape of the chamber 20 can be a reverse mushroom or other similar designs in which a pair of power nozzles 40 are provided on opposing axial/downstream edges of the chamber. Thus, the inner/downstream facing of island 30 will define an upstream perimeter for the chamber 20. Similarly, the power nozzles 40 and cold step 60 are aligned along the boundary of the interaction chamber. In each instance, it will be understood that references to the shape of the chamber 20 will necessarily involve corresponding adjustments to these defining/boundary features.

While flow is received into the chamber 20 via power nozzles 40 (and, in the reverse mushroom aspects, only through those two power nozzles), flow exits the chamber through the throat 12. The throat 12 is formed, preferably along and/or centered on the central axis A-A, in the portions 14 of boundary wall that run transversely and/or in parallel with the edge 4a. In some aspects, the wall portions are slightly angled, at less than 10° or less than 5°, to funnel and direct flow toward the throat 12 (i.e., the wall portions 14 slope downward gradually toward the central axis A-A). Toward the axial edges, the wall portions 14 curve upward to form the nub 13. In this manner, the inner surface of the boundary wall 11 at the downstream most edges leading into the interaction chamber 20 will present as a J- or fishhook (reverse J-) shape.

The island 30 possess a C-shape oriented orthogonally to the axis A-A. The inner (i.e., downstream along the top portions and closer to the axis A-A) portion 31 of the island 30 that faces the chamber 20 includes an upper nub 32 that protrudes toward the center of the interaction chamber 20 and/or toward the bumps 50. However, the lower-most extremity 33 of the island 30 is positioned further downstream and transversely away (i.e., closer to the edges of the insert 1) in comparison to the upper nub 32. The wall section of the island running between the nub 32 and the extremity 33 proceeds primarily on a straight line and forms a tapering or narrowing angle relative to the lower nub 13 that extends upwardly away from the bottom edge 4a as part of the boundary wall 11.

The power nozzles 40 terminate at the cold step 60 and are bounded on either side by the section of the island between nub 32 and extremity 33 on the upstream side, and by straight wall terminating in the nub 13 that extends upstream from the transverse section of boundary wall 11 along the bottom edge 4a. As a result, the walls defining the power nozzles 40 are angled toward one another and terminate at the narrowest point, which coincides with the cold step 60. In some aspects, the angle of taper can be between 5° and 35°, with additional aspects relying on an angle between 15° and 25°. The jets J that emanate from the power nozzles 40 are directed toward the midsection or upstream edges of the bumps 50, which tend to redirect flow as seen in FIG. 4B (and in contrast to conventional circuits, where jets P tend to proceed more quickly toward the throat 12). FIG. 4B also highlights how the flow can and will oscillate across the interior of the chamber 20.

The bumps 50 disposed on the floor of the interaction chamber 20 deflect a small amount of the flow out of the power nozzles to create additional turbulence, helping to start the oscillation needed for a fluidic fan. The bumps could posses a variety of different shapes, such as concave or convex arcs, circles, or most effectively in initial testing, kidney bean shapes 50a (FIGS. 1A and 2A) and pill shapes 50b (FIGS. 1B, 2B and 3A). In each instance, bumps 50 are raised or proud of the surface, as these show the most improvement. As previously noted, the bumps 50 will have a height or depth that is less than the drop of the cold step 60 and, in some aspects approximately one half to three quarters of that drop.

In some aspects, the bumps 50 will be symmetrical about the central axis. Preferably, there are two bumps both offset from one another and transversely away from the central axis. The axial positioning of the lower-most edge of the bumps 50 should be at or adjacent to the lower nub 13 defining the top edge of the power nozzles 40. The upper-most edge of the bumps extends upward and angles away from the upper nub 32. In this manner, the bumps 50 are arranged at an angle relative to the central axis A-A. In some aspects the bumps 50 are uniformly space apart from one another along the entirety of their axial length and/or uniformly spaced apart from each of the power nozzles 40 and inner facings 31 of the island 30.

The bumps 50 also angled toward one another so that their bottom ends diverge and are space farther apart than the upper ends. The width and height of the bumps is preferably consistent and constant, with the kidney bean bumps having a uniform C-shape.

Along with these bumps or depressions, cold step 60 drops the floor of the circuit from an upstream area to a lower/deeper floor in the interaction chamber 20. The relative magnitudes of the heights of the bumps 50 and cold step 60 can vary, but the height/depth of the bumps 50 should not exceed the drop of the cold step 60. In some aspects, the depth of the cold step 60 will be larger than the bumps 50. Generally speaking, the goal is that the top surface of the bumps 50, which are flat and usually parallel to the plane defined by the floor of interaction chamber 20 will be level with the power nozzles 40 (+/−0 to 30% difference), so as to ensure unobstructed path over the bump with only small portion of the flow being deflected (e.g., upstream or downstream, depending upon the oscillation stage at any given moment).

In some aspects, pill-shaped bumps 50b, with flat tops, are positioned directly in the natural path of jets J. Bumps 50b are angled inwards towards the top of the insert 1, so as to deflect flow upstream and into upper reaches of the interaction region. Without wishing to be bound by any theory of operation, slow motion photography suggests, especially at higher viscosities and/or lower flow rates in the reverse mushroom circuit, flow is otherwise unable to get into the upper portion of the interaction region in which fluidic switching otherwise occurs. Thus, as seen in FIG. 4A, conventional circuits without bumps 50 cannot create the necessary vortices needed for robust oscillation, especially at cold temperatures. With bumps 50b, just enough fluid is redirected up into the top portion of the interaction region to kickstart and maintain the necessary vortices at low pressures (as in FIG. 4B).

The shape of the interaction region modifiers, as well as their size, and direction (proud or sub flush) can all be changed to see varying degrees of effect. The top surface of the modifiers 50 can be flat topped, filleted, chamfered, or variable. In some aspects, the distance between the lower nub 13 of the power nozzle 40 and the downstream edge of each bump 50 will be less than the closest spacing between the upper inner facings of the bumps, with the spacing of the nozzle to bump being about 1 unit and the spacing between the bumps being between 1.2 and 1.6 units. In some aspects, the spacing of the nozzle to bump will be within +/−10% of the width of the bump (e.g., in a pill-shaped bump, the width as measured at the midpoint of the straight, parallel sides in the middle of the bump).

With the growing prominence/need for cleaning of sensors and camera systems, particularly in vehicles, there is a growing need for fluidic circuits that are capable of producing and maintaining spray characteristics over a range of temperatures (e.g., from −30° C. up to 75° C.) and fluid types (e.g., water, ethanol, methanol, isoproponal, ethylene glycol, etc.). Similarly, these systems may need to accommodate fluids having different viscosities (e.g., 9 cP up to 23 CP or more), as well as being provided over a range of flow rates (e.g., less than 400 mL/min at 22 psi). Generally speaking, “alcohol” will refer to pure alcohol, mixtures of water and alcohol(s), and mixtures of aqueous cleaning fluid (i.e., having additional additives) and alcohol(s). However, the circuits depicted herein have particular utility for ethanol-based fluids, and they show significant performance improvements in comparison to aqueous solutions and, separately, methanol mixtures.

Notably, in the automotive industry, anti-freezing agents used in cleaning solutions will vary by region and/or regulatory scheme. Thus, various alcohols (ethanol, isopropanol, methanol, etc.) may be mixed with water or other aqueous/miscible solutions at a variety of ratios (e.g., 50/50, 75/25, etc.). Further, insofar as operating conditions routinely vary from −20° C. up to in excess of 45° or 50° C., the viscosity of fluids passing through the fluidic geometry can vary by a factor of 3 or more (with higher viscosities encountered at lower temperatures). As used herein, low temperature performance means that the spray fans (in terms of size and volume of fluid delivered) remain comparatively constant at the upper and lower ends of these ranges, although automobile manufacturers place a premium on performance at ambient/mid-range and low temperatures, with the interaction chamber modifications contemplated herein performing particularly well at cold temperatures and at comparative low pressures (e.g., less than 20 psi/1.38 bar, less than 15 psi/1.03 bar, and even less than 10 psi/0.69 bar).

Various disclosed aspects have proven most successful in low pressure operation, in order to reliably open and maintain the desired fan spray, even at low pressure. In most tested configurations, the fan is very good at low pressure, although it may collapse in the mid range before opening again at high pressures. Thus, whereas the utility of these aspects may be more limited in comparison to conventional designs for a general 22 psi washer nozzle circuit, the invention excels in low-pressure systems (˜10 psi/0.69 bar or less) so that its spray fan will be vastly superior to any of the aforementioned circuits, irrespective of whether they dispense water, methanol, and/or ethanol.

Fluidic circuits involve a multiplicity of variables, including the dimensions of features found in the interaction chamber; the comparative depth of the inlet, the interaction chamber, and/or the outlet; the anticipated operating temperature and pressure of the fluid within the circuit (with the further understanding that the composition of that fluid will further impact its flow characteristics), and the desired properties of the spray fan produced by the circuit. As such, it will be understood that the presence or absence of any particular feature can have significant and unpredictable impacts on the performance of the fluidic circuit. Consequently, selected aspects of the invention include strict adherence to providing only the features described for that particular aspect (i.e., the absence of other features may, in and of itself, contribute significantly to the invention/performance of the circuit).

In view of the foregoing, one aspect of the invention contemplates a fluidic circuit, formed in a facing of an insert body having a central axis and configured to produce an oscillating spray fan of fluid at temperatures within 10° C. of a freezing point of the fluid and/or at fluid pressures within the circuit of less than 1.03 bar. That circuit will comprise or consist of a boundary wall surrounding the fluidic circuit including an upstream edge, opposing axial sides, and a downstream edge and wherein the downstream edge of the boundary wall includes a throat in communication with an outlet; an inlet region located within the boundary walls and positioned closest to the upstream edge, wherein the inlet region is formed at first depth within the facing; an interaction chamber: i) having a floor formed at a second depth that is greater than the first depth and a pair of interaction region modifiers, ii) positioned downstream from and in communication with the inlet region via a pair of opposing power nozzles, and ii) defined at an upstream portion by an island interposed between the inlet region and the floor; wherein each of the pair of opposing power nozzles is: i) defined by opposing downstream edges of the island and the downstream portions of the boundary wall bounding the throat, and ii) includes a cold step drop equal to a difference between the first depth and the second depth; and wherein each of the pair of interaction region modifiers: i) is associated with one of the power nozzles, and ii) extend into or away from the floor of the interaction chamber to a distance orthogonal to the floor that is equal to or less than the cold step drop. Additional aspects may include any one or combination of the following features:
wherein a fluidic geometry is selected from a mushroom, a reverse mushroom, or a three-jet island;
wherein the island has a C-shape with an upstream facing matching the first depth and a downstream facing matching the second depth;
wherein the inlet region and the interaction chamber do not include any other islands or features and wherein only two power nozzles are provided within the fluidic circuit;
wherein terminal downstream edges on each side of the C-shape include upper nubs that extend into the interaction chamber at an upstream angle;
wherein the downstream portions of the boundary wall include lower nubs so that the upper and lower nubs define a narrowest exit point for each power nozzle;
wherein each power nozzle gradually narrows at an angle as it approaches the narrowest exit point;
wherein the angle of the power nozzle tapering is between 5° and 30°;
wherein each of the pair of interaction region modifiers extend away from the floor of the interaction chamber;
wherein each of the pair of interaction region modifiers are oriented at an angle relative to the central axis so that an upstream modifier edge is closer to the central axis in comparison to a downstream modifier edge;
wherein each of the pair of interaction region modifiers has an identical shape selected from a bean-shape or a pill-shape;
wherein a spacing between the pair of interaction region modifiers at the upstream modifier edges is greater than a shortest distance between each of the pair of interaction region modifiers at the downstream modifier edge and the power nozzle associated therewith;
wherein the downstream edge of the boundary wall on each side of the throat is: i) symmetrical relative to the central axis, and ii) aligned at an angle between 1° and 10° relative to a transverse line that is perpendicular to the central axis; and
wherein the outlet and all components constituting the interaction chamber are symmetrical relative to the central axis.

All components should be made of materials having sufficient flexibility and structural integrity, as well as a chemically inert nature and resistant to corrosion and other conditions commonly encountered by exterior vehicle components. Certain grades of injection-moldable polymers may be particularly advantageous, as will various processes for forming detailed shapes in/on metallic, polymeric, composite, or other types of blocks of materials.

References to coupling in this disclosure are to be understood as encompassing any of the conventional means used in this field. This may take the form of snap- or force fitting of components, although threaded connections, bead-and-groove, and bayonet-style/slot-and-flange assemblies could be employed. Adhesive and fasteners could also be used, although such components must be judiciously selected in view of the design considerations noted above.

In the same manner, engagement may involve coupling or an abutting relationship. These terms, as well as any implicit or explicit reference to coupling, will should be considered in the context in which it is used, and any perceived ambiguity can potentially be resolved by referring to the drawings.

Any reference to angles being formed herein will entail measuring the two components along their longest/most consistent straight edge relative to one another. Thus, when establishing, as one example, a tapering angle for the power nozzles, it will be understood that the straight edge portions of the upstream and downstream walls defining that power nozzle will be used to calculate the angle (while disregarding the rounded/curving edges). Further, certain references to angles may relative to the central axis (which is also representative of the upstream to downstream flow) or the bottom/downstream edge of the insert in a transverse direction that is orthogonal to the central axis. Context of the disclosure and reference to the drawings can be relied upon to resolve any ambiguities.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

We claim:

1. A fluidic circuit, formed in a facing of an insert body having a central axis and configured to produce an oscillating spray fan of fluid at temperatures within 10° C. of a freezing point of the fluid and/or at fluid pressures within the circuit of less than 1.03 bar, the fluidic circuit comprising:
a boundary wall surrounding the fluidic circuit including an upstream edge, opposing axial sides, and a downstream edge and wherein the downstream edge of the boundary wall includes a throat in communication with an outlet;
an inlet region located within the boundary walls and positioned closest to the upstream edge, wherein the inlet region is formed at first depth within the facing;
an interaction chamber: i) having a floor formed at a second depth that is greater than the first depth and a pair of interaction region modifiers, ii) positioned downstream from and in communication with the inlet region via a pair of opposing power nozzles, and ii) defined at an upstream portion by an island interposed between the inlet region and the floor;
wherein each of the pair of opposing power nozzles is: i) defined by opposing downstream edges of the island and the downstream portions of the boundary wall bounding the throat, and ii) includes a cold step drop equal to a difference between the first depth and the second depth; and
wherein each of the pair of interaction region modifiers: i) is associated with one of the power nozzles, and ii) extend into or away from the floor of the interaction chamber to a distance orthogonal to the floor that is equal to or less than the cold step drop.

2. The fluidic circuit of claim 1 wherein a fluidic geometry is selected from a mushroom, a reverse mushroom, or a three-jet island.

3. The fluidic circuit of claim 1 wherein the island has a C-shape with an upstream facing matching the first depth and a downstream facing matching the second depth.

4. The fluidic circuit of claim 3 wherein the inlet region and the interaction chamber do not include any other islands or features and wherein only two power nozzles are provided within the fluidic circuit.

5. The fluidic circuit of claim 3 wherein terminal downstream edges on each side of the C-shape include upper nubs that extend into the interaction chamber at an upstream angle.

6. The fluidic circuit of claim 5 wherein the downstream portions of the boundary wall include lower nubs so that the upper and lower nubs define a narrowest exit point for each power nozzle.

7. The fluidic circuit of claim 6 wherein each power nozzle gradually narrows at an angle as it approaches the narrowest exit point.

8. The fluidic circuit of claim 7 wherein the angle is between 5° and 30°.

9. The fluidic circuit of claim 3 wherein each of the pair of interaction region modifiers extend away from the floor of the interaction chamber.

10. The fluidic circuit of claim 9 wherein each of the pair of interaction region modifiers are oriented at an angle relative to the central axis so that an upstream modifier edge is closer to the central axis in comparison to a downstream modifier edge and wherein each of the pair of interaction region modifiers has an identical shape selected from a bean-shape or a pill-shape.

11. The fluidic circuit of claim 1 wherein each of the pair of interaction region modifiers extend away from the floor of the interaction chamber.

12. The fluidic circuit of claim 11 wherein each of the pair of interaction region modifiers are oriented at an angle relative to the central axis so that an upstream modifier edge is closer to the central axis in comparison to a downstream modifier edge.

13. The fluidic circuit of claim 12 wherein each of the pair of interaction region modifiers has an identical shape selected from a bean-shape or a pill-shape.

14. The fluidic circuit of claim 12 wherein a spacing between the pair of interaction region modifiers at the upstream modifier edges is greater than a shortest distance between each of the pair of interaction region modifiers at the downstream modifier edge and the power nozzle associated therewith.

15. The fluidic circuit of claim 1 wherein the downstream edge of the boundary wall on each side of the throat is: i) symmetrical relative to the central axis, and ii) aligned at an angle between 1° and 10° relative to a transverse line that is perpendicular to the central axis.

16. The fluidic circuit of claim 1 wherein the outlet and all components constituting the interaction chamber are symmetrical relative to the central axis.
